(19) United States
(12) Patent Application Publication
(10) Pub. No.: US 2014/0282916 A1
(43) Pub. Date: Sep. 18, 2014

(54) ACCESS AUTHORIZATION THROUGH CERTIFICATE VALIDATION

(71) Applicant: AEROHIVE NETWORKS, INC., Sunnyvale, CA (US)

(72) Inventor: Matthew Stuart Gast, San Francisco, CA (US)

(73) Assignee: AEROHIVE NETWORKS, INC., Sunnyvale, CA (US)

(21) Appl. No.: 14/216,313

(22) Filed: Mar. 17, 2014

Related U.S. Application Data
(60) Provisional application No. 61/802,186, filed on Mar. 15, 2013.

(51) Int. Cl. H04L 29/06

(52) U.S. Cl. CPC H04L 63/0823; H04L 63/10
USPC 726/4

(57) ABSTRACT

Managing access for a client device to services or data provided through a network using a certificate received from a client device that is either an employee owned device or an employer owned device. User information of a user of the client device and device information of the client device is determined from the certificate. Access rights for the client device are determined based on the user information and the device information. Access to services or data provided through a network for the client device are managed using the determined access rights.

### CROSS-REFERENCE TO RELATED APPLICATIONS

This application claims priority to U.S. Provisional Application Ser. No. 61/802,186, filed Mar. 15, 2013, and entitled, “ACCESS AUTHORIZATION THROUGH CERTIFICATE VALIDATION,” which is incorporated by reference.

### BACKGROUND

An area of ongoing research and development is in employees bringing their own devices and connecting to an employer owned network using the devices. In particular, research and development has explored how to provide appropriate access to devices that are brought by employees.

One key problem presented by the Bring-Your-Own-Device (hereinafter referred to as “BYOD”) movement is that IT departments do not want to trust employee owned devices to the same extent that they trust employer owned devices. Wireless network authentication protocols such as EAP authenticate the device (MAC address) through a user account, but do not have the native capability to distinguish between an employee-owned device and a corporate-owned device without additional capabilities.

The foregoing examples of the related art and limitations related therewith are intended to be illustrative and not exclusive. For example, wireless clients may use different protocols other than 802.11, potentially including protocols that have not yet been developed. However, problems associated with multiple authentications may persist. Other limitations of the relevant art will become apparent to those of skill in the art upon reading the specification and studying of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for managing access for a client device to services or data provided through a network using a certificate received from a client device that is either an employee owned device or an employer owned device. In various implementations, user information of a user of the client device and device information of the client device is determined from the certificate. Further in various implementations, access rights for the client device are determined based on the user information and the device information. In various implementations, access to services or data provided through a network for the client device are managed using the determined access rights.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for managing access to services and data provided through a network using a certificate.

FIG. 2 depicts a diagram of an example of a system for assigning a certificate used in managing access to services and data provided through a network.

FIG. 3 depicts a diagram of an example of a system for managing a client devices access to service and data provided through a network using a certificate.

FIG. 4 depicts a diagram of an example of a system for determining whether a certificate received from a client device is valid.

FIG. 5 depicts a diagram of an example of a system for determining access rights for a client device to services and data provided through a network based on a certificate received from the client device.

FIG. 6 depicts a flowchart of an example of a method for generating a certificate for a client device or a user of a client device for use in managing access to services and data provided through a network.

FIG. 7 depicts a flowchart of an example of a method for determining validity of a certificate received from a client device for accessing services or data provided through a network.

FIG. 8 depicts a flowchart of an example of a method for determining access rights for a client device to services and data provided through a network using a certificate received from the client device.

### DETAILED DESCRIPTION

FIG. 1 depicts a diagram 100 of an example of a system for managing access to services and data provided through a network using a certificate. The example system shown in FIG. 1 includes a computer-readable medium 102, a client device 104, a network device 106, a certificate assignment system 108, a certificate datastore 110, an access rights datastore 112, and a certificate based validity and access rights management system 114.

In the example system shown in FIG. 1, the client device 104 is coupled to the network device 106 and the network device 106, the certificate assignment system 108, the certificate datastore 110, the access rights datastore 112, and the certificate based validity and access rights management system 114 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a network.

Assuming the computer-readable medium 102 includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet. The example of FIG. 1 is intended to illustrate a computer-readable medium 102 that may or may not include more than one private network.

The computer-readable medium 102, the client device 104, the network device 106, the certificate assignment system 108, the certificate based validity and access rights management system 114, and other systems, or devices described in this paper can be implemented as a computer system or parts of a computer system or a plurality of computer systems. A computer system, as used in this paper, is intended to be construed broadly and can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific, configuration-specific, or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the FIGs. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the client device 104 is an applicable device that functions to send data to and receive data from a network. The client device 104 can send and receive data through a network device that is part of a network. Depending upon implementation-specific, or other considerations, the client device 104 can be a thin client device or an ultra-thin client device. Data sent and receive by the client device 104 can be used in executing applications, e.g. a web browser or Apple FACETIME®, on the client device 104.

In a specific implementation, the network device 106 functions to transmit data between a client device and a network. In transmitting data between a client device and a network, the network device 106 can couple the client device to the network. A network device, as used in this paper, can include by way of example but not limitation an access point, a gateway, a switch, a router, or the like. Data transmitted by the network device 106 can be used in the execution of an application, e.g. Apple FACETIME®, on the client device.

In a specific implementation, the client device 104 includes a station and is coupled to the network device 106 through a wireless connection. A station, as used in this paper, can be referred to as a device with a media access control (MAC) address and a physical layer (PHY) interface to a wireless medium that complies with the IEEE 802.11 standard. Thus, for example, the network devices 106 and 108 can be referred to as stations, if applicable. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. Wi-Fi is a non-technical description that is generally correlated with the IEEE 802.11 standards, as well as Wi-Fi Protected Access (WPA) and WPA2 security standards, and the Extensible Authentication Protocol (EAP) standard. In alternative embodiments, a station may comply with a different standard than Wi-Fi or IEEE 802.11, may be referred to as something other than a “station,” and may have different interfaces to a wireless or other medium.

In a specific implementation, in which the client device 104 is coupled to the network device 106 through a wireless connection, applicable devices, systems and engines described in this paper, may or may not be IEEE 802 standards compatible or IEEE 802 standards-compliant. As used in this paper, IEEE 802 standards-compatible or IEEE 802 standards-compliant complies with at least some of one or more of the incorporated documents' requirements and/or recommendations, or requirements and/or recommendations from earlier drafts of the documents, and includes Wi-Fi systems.

In a specific implementation, the certificate assignment system 108 functions to assign a certificate to a client device that first couples to a network. A certificate assigned to a client device by the certificate assignment system 108 can be used to determine and manage access rights to services or data provided through a network to the client device. Depending upon implementation-specific or other considerations, a certificate assigned to a client device by the certificate assignment system 108 can be used to determine an identification of a user of the client device, included as part of user information as used in this paper, that is used to manage access to rights to service or data. Further depending upon implementation-specific or other considerations, a certificate assigned to a client device by the certificate assignment system 108 can be used to determine, as part of device information as used in this paper, whether the client device is issued by an employer or is the property of an employee, e.g. a BYOD. Depending upon implementation-specific or other considerations, a certificate assigned to a client device by the certificate assignment system 108 can be used to determine a group, as part of user information as user in this paper, of which a user of the client device is a member. For example, if a user is in the IT department, then a certificate assigned to a client device used by or associated with the user can be used to determine that the user is part of the IT department.

In a specific implementation, in generating a certificate for a client device, the certificate assignment system 108 can determine device information for the client device. Device information of a client device determined by the certificate assignment system 108 can include an identification of the client device, e.g. a MAC address of the client device. In generating a certificate for a client device, the certificate assignment system 108 can generate a certificate that includes a determined identification of the client device. For example, the certificate assignment system 108 can generate a certificate for a client device that includes a MAC address of the client device. As a result, a certificate generated by the certificate assignment system 108 for a client device can be bound to the client device. Device information of a client device determined by the certificate assignment system 108 can include whether the client device is a BYOD or an employer owned device. In generating a certificate for a client device, the certificate assignment system 108 can generate a certificate that includes whether the client device is a BYOD or an employer owned device.

In a specific implementation, in generating a certificate for a client device, the certificate assignment system 108 can determine user information of a user of a user of the client device. User information of a client device determined by the certificate assignment system 108 can include an identification of a user of the client device. User information of a client device determined by the certificate assignment system 108 can also include a group of which a user of the client device is a member. For example, if a user is in the IT department, the certificate assignment system 108 can determine that the user is part of the IT department. In generating a certificate for a client device, the certificate assignment system 108 can include user information of a user of the client device in the certificate. For example, if a device were used by a user who is a member of the IT department, it would have the Subject Name of O=Aerohive Networks, OU=Information Technology, uid=mgast@aerohive.com, plus any other extended key usage attributes that are required by the BYOD enrollment system.

In a specific implementation, the certificate datastore 110 functions to store certificate data for a certificate that is assigned to a client device. Certificate data stored in the certificate datastore 110 can be stored as a table that includes an assigned certificate or an identification of the assigned certificate as an index in the table. Certificate data can also indicate whether a particular certificate is still valid or has been revoked. Depending upon implementation-specific or other considerations, certificate data stored in the certificate datastore 110 can include device information of a client device to which the certificate is assigned. For example, certificate data stored in the certificate datastore 110 can include either or both an identification of a client device, e.g. a MAC address, and whether the client device is a BYOD or an employer owned device. Further depending upon implementation-specific or other considerations, certificate data stored in the certificate datastore 110 can include user information of a client device to which the certificate is assigned. For example, certificate data stored in the certificate datastore 110 can include either or both an identification of a user of a client device or an identification of groups that a user of the client device is a member.

In a specific implementation, in including certificate data stored in the certificate datastore 110 that corresponds to a certificate, the certificate can be considered to be “self-describing.” In being “self-describing,” a certificate along with certificate information can be used to determine access rights for a client device to which the certificate is assigned.

In a specific implementation, the certificate assignment system 108 can revoke a certificate that is previously assigned to a client device. In determining whether to revoke a certificate, the certificate assignment system 108 can determine whether a user of a client that the certificate is assigned to is still employed by a company. Depending upon implementation-specific or other considerations, the certificate assignment system 108 can revoke a certificate if it is determined that a user of a client device that the certificate is assigned to is no longer employed by a company. In determining whether to revoke a certificate, the certificate assignment system 108 can determine whether the certificate has expired. Further depending upon implementation-specific or other considerations, the certificate assignment system 108 can revoke a certificate or renew a certificate if it is determined that the certificate has expired. In revoking a certificate, the certificate assignment system 108 can update certificate data stored in the certificate datastore 110 to indicate that the certificate has been revoked and is no longer valid.

In a specific implementation, the access rights datastore 112 functions to store access rights data that includes access rights rules. Access rights rules stored in the access rights datastore 112 can include rules that are used to determine access rights for a client device or a user of the client device based on user information of the user of the client device and/or device information of the client device. Access rights rules can specify a degree to grant access to services or data provided by a network to either a client device or a user of the client device based on device information and/or user information associated with the client device. For example, access rights rules can specify to grant full access to all IT services and data used in performing IT services, if user information of a user who uses a client device indicates that the user is a member of the IT group. In another example, access rights rules can specify to grant limited access to service and data through a network if device data for a client device indicates that the client device is a BYOD.

In a specific implementation, the access rights datastore 112 functions to store access rights data that includes specific access rights. Specific access rights can be specific to either or both a client device or a user of the client device. In being specific to a client device, specific access rights can specify what access rights to grant for services or data provided through a network to the client device, regardless of a user of the client device. For example, specific access rights can specify access rights for a client device based on an identification of a client device. In being specific to a user, specific access rights can specify what access right to grant for services or data provided through a network to a client device used by the user. For example, specific access rights can specify access rights for a user of a client device based on an identification of the user.

In a specific implementation, the certificate based validity and access rights management system 114 functions to determine a validity of a certificate of a client device. Depending upon implementation-specific or other considerations, in determining validity of a certificate of a client device, the certificate based validity and access rights management system 114 can determine whether a user has tampered with the certificate, and is therefore not valid. The certificate based validity and access rights management system 114 can determine whether a user has modified a certificate. For example, the certificate based validity and access rights management system 114 functions to determine whether a user has modified the subject of a certificate to gain more rights to access services or data provided by a network. In another example, the certificate based validity and access rights management system 114 can determine whether a user has modified a certificate to change whether a client device associated with a certificate is a BYOD or an employer owned device. In determining whether a certificate has been tampered with, the certificate based validity and access rights management system 114 can cryptographically determine whether a user has tampered with the certificate.

In a specific implementation, a certificate can be revoked if it is determined that it has been tampered with by the certificate based validity and access rights management system 114. Depending upon implementation-specific or other considerations, the certificate assignment system 108 can update certificate data stored in the certificate datastore 110 to indicate that a certificate has been revoked, if the certificate based validity and access rights management system 114.

In a specific implementation, in determining validity of a certificate, the certificate based validity and access rights management system 114 functions to determine whether a certificate has been revoked, and is therefore not valid. In determining whether a certificate has been revoked, the certificate based validity and access rights management system 114, can use certificate data stored in the certificate datastore 110. Specifically, the certificate based validity and access rights management system 114 can look up in certificate data, based on an identification of a certificate, to determine whether the certificate is valid or has been revoked. Depending upon implementation-specific or other considerations, the certificate assignment system 108 can generate certificate data that indicates whether a certificate is valid or has been revoked.

In a specific implementation, in determining validity of a certificate, the certificate based validity and access rights management system 114 functions to determine if the certificate is received from a device to which the certificate is bound, and is therefore valid. In determining whether a certificate is received from a client device that the certificate is bound to, the certificate based validity and access rights management system 114 can determine an identification of the client device, e.g. a MAC address of the client device. Further in determining whether a certificate is received from a client device that the certificate is bound to, the certificate based validity and access rights management system 114 can look up an identification of a client device that the certificate is bound to in certificate data stored in the certificate datastore 110. The certificate based validity and access rights management system 114 can match an identification of a client device that the certificate is bound to with an identification of a client device that sends the certificate to determine if the client device that sends the certificate is the client device to which the certificate is bound.

In a specific implementation, the certificate assignment system functions to revoke a certificate if it is determined by the certificate based validity and access rights management system 114 that a client device that sends the certificate is not a client device that is bound to the certificate. In revoking a certificate if a client device that sends the certificate is not a client device that is bound to the certificate, can update certificate data stored in the certificate datastore 110 to reflect that the certificate has been revoked.

In a specific implementation, the certificate based validity and access rights management system 114 functions to determine access rights based on a certificate received from the client device. In determining access rights based on a certificate sent from the client device, the certificate based validity and access rights management system 114 can use access rights data stored in the access rights datastore 112. The certificate based validity and access rights management system 114 can determine user information and device information included as part of the certificate and determine access rights based on the determined user information and device information. For example, the certificate based validity and access rights management system 114 can determine a group that a user of a client device is a member of from a certificate, and determine access rights for the client device based on the group of which the user of the client is a member. In another example, the certificate based validity and access rights management system 114 can determine an identification of a user of a client device from a certificate, and determine access rights for the client device based on the identification of the user. Depending upon implementation-specific or other considerations, the certificate based validity and access rights management system 114 can determine access rights from specific access rights stored in the access rights datastore 112 based on determined device information or user information. Further depending upon implementation-specific or other considerations, the certificate based validity and access rights management system 114 can determine access rights from access rights rules stored in the access rights datastore 112 based on determined device information or user information.

In a specific implementation, the certificate based validity and access rights management system 114 functions to determine access rights based on a certificate received from a client device and certificate data stored in the certificate datastore 110. In determining access rights based on a certificate sent from a client device and certificate data stored in the certificate datastore 110, the certificate based validity and access rights management system 114 can use access rights data stored in the access rights datastore 112. The certificate based validity and access rights management system 114 can determine user information and device information from certificate data stored in the certificate datastore 110 that corresponds to a certificate received from a client device. For example, the certificate based validity and access rights management system 114 can determine a group that a user of a client device is a member of from user information, included as part of certificate information, corresponding to a certificate received from the client device, and determine access rights based on the group of which the user of the client device is a member. In another example, the certificate based validity and access rights management system 114 can determine an identification of a user of a client device from user information, included as part of certificate information, corresponding to a certificate received from the client device, and determine access rights based on the identification of the user. Depending upon implementation-specific or other considerations, the certificate based validity and access rights management system 114 can determine access rights from specific access rights stored in the access rights datastore 112 based on determined device information or user information. Further depending upon implementation-specific or other considerations, the certificate based validity and access rights management system 114 can determine access rights from access rights rules stored in the access rights datastore 112 based on determined device information or user information.

In a specific implementation, the certificate based validity and access rights management system 114 functions to manage access to services and data provided through a network based on determined access rights for a client device. In managing client device access to data and services through a network, the certificate based validity and access rights management system 114 can allow the client device or a user of the client device to utilize services and receive data authorized by the access rights determined specifically for the client device or a user of the client device. For example, if access rights indicate that a client device or a user of the client device is not allowed to receive streaming data, then the certificate based validity and access rights management system 114 can block streaming data, or an application running on the client device that uses streaming data. Specifically, if a client device attempts to stream a video through a web browser, then the certificate based validity and access rights management system 114 can stop the transmission of data used in streaming the video through the web browser.

In a specific implementation, the certificate based validity and access rights management system 114 functions to manage access to services and data based on whether it is determined that a certificate is valid, e.g. the certificate has not been tampered with, was sent by a client device that the certificate is bound to, and/or has not been revoked. Depending upon implementation-specific or other considerations, in managing access to services and data based on whether a certificate is valid, the certificate based validity and access rights management system 114 can deny access for a client device to services and data provided through a network. For example, the certificate based validity and access rights management system 114 can terminate a connection or not allow a client device to connect to a network that provides services or data if it determines that a certificate received from the client device is not valid. Further depending upon implementation-specific or other considerations, in managing access rights based on whether a certificate is valid, the certificate based validity and access rights management system 114, can limit access for a client device to services and data provided through a network. For example, the certificate based validity and access rights management system 114 can enroll a client device in a limited profile, e.g. a guest profile, and allow the client device to connect to a network through the limited profile if it is determined that a certificate sent by the client device is not valid. In the example, the profile can be limited with respect to access rights to services and data provided through the network. In another example, the certificate based validity and access rights management system 114 can give a client device access to a network, but place the client device in a user profile that contains only a captive web portal indicating that the certificate that the client device is using is not bound to the client device and the user must contact IT.

In an example of operation of the example system shown in FIG. 1, the certificate assignment system 108 assigns a certificate to the client device 104 that is coupled to a network through the network device 106. In the example of operation of the example system shown in FIG. 1, the certificate assignment system determines user information of a user of the client device 104 and device information of the client device 104 and associates the user information and the device information with the certificate assigned to the client device 104. Further in the example of operation, the certificate assignment system 108 includes the device information and the user information in the certificate that is assigned to the client device 104. In the example of operation, the certificate assignment system 108 generates certificate data that is stored in the certificate datastore 110 that includes an identification of the certificate assigned to the client device 104 and the user information and the device information associated with the certificate.

In the example of operation of the example system shown in FIG. 1, the certificate based validity and access rights management system 114 determines whether a certificate received from the client device 104 is valid. Further in the example of operation, the certificate based validity and access rights management system 114 determines access rights for the client device 104 or a user of the client device 104 based on the certificate received from the client device 104, certificate data stored in the certificate datastore 110, and access rights data stored in the access rights datastore 112. In the example of operation, the certificate based validity and access rights management system 114 manages access for the client device 104 to services and data provided through a network based on determined access rights.

FIG. 2 depicts a diagram 200 of an example of a system for assigning a certificate used in managing access to services and data provided through a network. The example system shown in FIG. 2 includes a computer-readable medium 202, a client device 204, a network device 206, a certificate assignment system 208, and a certificate datastore 210. In the example system shown in FIG. 2, the client device 204 is coupled to the network device 206 and the network device 206, the certificate assignment system 208, and the certificate datastore 210 are coupled to each other through the computer-readable medium 202.

In a specific implementation, the client device 204 functions according to an applicable device for sending and receiving data through a network, such as the client devices described in this paper. In receiving data through a network, the client device 204 can receive a certificate that is assigned to the client device 204. Additionally, in receiving data through a network, the client device 204 can access services or data provided through the network. In sending data through a network, the client device 204 can send a certificate that is assigned to the client device 204.

In a specific implementation, the network device 206 functions according to an applicable device for coupling a client device to a network, such as the network devices described in this paper. In coupling a client device to a network, the network device 206 can send and receive data between a network and a client device that is coupled to the network device 206. Depending upon implementation-specific or other considerations, a client device can be coupled to the network device 206 through a wired or wireless connection.

In a specific implementation, the certificate assignment system 208 functions according to an application system for generating and assigning a certificate to a client device, such as the certificate assignment systems described in this paper. Certificates assigned to a client device by the certificate assignment system 208 can be used in determining access rights of a client device to services and data provided through a network. In determining access rights based on certificates assigned to client devices by the certificate assignment system, certificates assigned to client devices by the certificate assignment system 208 can be used in managing access to services or data provided through a network.

In a specific implementation, the certificate datastore 210 functions according to an applicable datastore for storing certificate data, such as the certificate datastores described in this paper. Certificate data stored in the certificate datastore 210 can include a certificate or an identification of the certificate assigned to a specific device. In including a certificate or an identification of the certificate as part of certificate data, certificate data stored in the certificate datastore 210 can be arranged as a table, with the certificate or the identification of the certificate as an index in the table. Certificate data stored in the certificate datastore 210 can also include user information and device information. For example, certificate data stored in the certificate datastore 210 can include an identification of a client device, e.g. MAC address of the client device.

In the example system shown in FIG. 2, the certificate assignment system 208 includes a device information determination engine 212, a user information determination engine 214, and a certificate generation engine 216. In a specific implementation, the device information determination engine 212 functions to determine device information of a client device for which the certificate assignment system 208 is assigning a certificate. For example, the device information determination engine 212 can determine an identification of a client device, e.g. a MAC address. In another example, the device information determination engine 212 can determine whether a client device is a BYOD or an employer owned device. Depending upon implementation-specific or other considerations, in determining whether a client device is a BYOD or an employer owned device, the device information determination engine 212 can look up an identification of the client device in a table or datastore that lists the identification of client devices that are employer owned.

In a specific implementation, the user information determination engine 214 functions to determine user information of a user using a client device for which the certificate assignment system 208 is assigning a certificate. For example, the user information engine 214 can determine a group of which a user is a member. In another example, the user information engine 214 can determine an identification of a user, e.g. a user's name. Depending upon implementation-specific or other considerations, the user information determination engine 214 can determine user information for a user by querying the user of a client device.

In a specific implementation, the certificate generation engine 216 functions to generate a certificate that is specific to a client device. After generating a certificate that is specific to a client device, the certificate generation engine 216 can send the certificate to the client device.

In a specific implementation, the certificate generation engine 216 functions to generate a certificate for a client device that includes device information for the client device. The certificate generation engine 216 can include device information determined by the device information determination engine 212 in a certificate. Device information of a client device included in a certificate by the certificate generation engine 218 can include an identification of the client device, e.g. a MAC address of the client device. Device information of a client device included in a certificate by the certificate engine 218 can also include whether the client device is a BYOD or an employer owned device.

In a specific implementation, the certificate generation engine 216 functions to generate a certificate for a client device that includes user information of a user of the client device. The certificate generation engine 216 can include user information determined by the user information determination engine 214 in a certificate. User information of a user that is included in a certificate by the certificate generation engine 218 can include an identification of a user of the client device. User information that is included in a certificate by the certificate generation engine 218 can also include a group of which a user of the client device is a member. For example, if a user is in the IT department, the certificate generation engine 216 can generate a certification that includes an identification that the user is in the IT department.

In a specific implementation, the certificate generation engine 216 associates user information and device information of a client device and a user of the client device with a specific certificate generated for the client device. Further in the specific implementation, the certificate generation engine 216 can update certificate data stored in the certificate datastore 210 based on user information and device information of a client device and a user of the client device associated with a specific certificate generated for the client device. For example, the certificate generation engine 216 can include user information and device information of a client device and a user of the client device associated with a specific certificate generated for the client device as certificate data stored in the certificate datastore 210 along with the specific certificate or an identification of the specific certificate.

In an example of operation of the example system shown in FIG. 2, the device information determination engine 212 determines device information of the client device 204. In the example of operation, the user information determination engine 214 determines user information of a user of the client device 204. Further in the example of operation, the certificate generation engine 216 generates a certificate that includes user information determined by the user information determination engine 214 and/or device information determined by the device determination engine 212. In the example of operations, the certificate generation engine 216 sends the generated certificate to the client device 204 through the network device 206. Additionally in the example of operations, the certificate generation engine 216 associates the user information and the device information with the certificate it generates, and updates certificate data in the certificate datastore 210 to include the user information, the device information, and the certificate or an identification of the certificate.

FIG. 3 depicts a diagram 300 of an example of a system for managing a client devices access to service and data provided through a network using a certificate. The example system shown in FIG. 3 includes a computer-readable medium 302, a client device 304, a network device 306, a certificate based validity and access rights management system 308, a certificate datastore 310, and an access rights datastore 312. In the example system shown in FIG. 3, the client device 304 is coupled to the network device 306 and the network device 306, the certificate based validity and access rights management system 308, the certificate datastore 310, and the access rights datastore 312 are coupled to each other through the computer-readable medium 302.

In a specific implementation, the client device 304 functions according to an applicable device for sending and receiving data through a network, such as the client devices described in this paper. In receiving data through a network, the client device 304 can receive a certificate that is assigned to the client device 304. Additionally, in receiving data through a network, the client device 304 can access services or data provided through the network. In sending data through a network, the client device 304 can send a certificate that is assigned to the client device 304.

In a specific implementation, the network device 306 functions according to an applicable device for coupling a client device to a network, such as the network devices described in this paper. In coupling a client device to a network, the network device 306 can send and receive data between a network and a client device that is coupled to the network device 306. Depending upon implementation-specific or other considerations, a client device can be coupled to the network device 306 through a wired or wireless connection.

In a specific implementation, the certificate based validity and access rights management system 308 functions according to an applicable system for managing client device access to services and data provided through a network, such as the certificate based validity and access rights management systems described in this paper. In managing client device access to services and data provided through a network, the certificate based validity and access rights management system 308 can determine whether a certificate received from a client device is valid. Further in managing client device access to services and data provided through a network, the certificate based validity and access rights management system 308 can determine access rights for a client device using a certificate. The certificate based validity and access rights management system 308 can manage access for a client device to services and data provided through a network based on determined access rights.

In a specific implementation, the certificate datastore 310 functions according to an applicable datastore for storing certificate data, such as the certificate datastores described in this paper. Certificate data stored in the certificate datastore 310 can include a certificate or an identification of the certificate assigned to a specific device. In including a certificate or an identification of the certificate as part of certificate data, certificate data stored in the certificate datastore 310 can be arranged as a table, with the certificate or the identification of the certificate as an index in the table. Certificate data stored in the certificate datastore 310 can also include user information and device information. For example, certificate data stored in the certificate datastore 310 can include an identification of a client device, e.g. MAC address of the client device. Certificate data stored in the certificate datastore 310 can also indicate whether a certificate has been revoked.

In a specific implementation, the access rights datastore 312 functions according to an applicable datastore for storing access rights data, such as the access rights datastores described in this paper. Access rights data stored in the access rights datastore 312 can include access rules that are used to determine a degree of which to provide access to services or data provided through a network to a client device based on user information of a user using the client device or client device information of the client device. Access data stored in the access rights datastore 312 can also include specific access rules that are specific to a client device or a user of a client device.

In the example system shown in FIG. 3, the certificate based validity and access rights management system 308 includes a certificate validity system 314, a certificate based access rights determination system 316, and an access management engine 318. In a specific implementation, the certificate validity system 314 determines whether a certificate is valid. The certificate validity system 314 can determine whether a certificate received from the client device 304 though the network device 306 is valid.

In a specific implementation, in determining validity of a certificate, the certificate validity system 314 functions to determine whether a user has tampered with a certificate received from the client device 304, and the certificate is therefore not valid. The certificate validity system 314 can determine whether a user has modified a certificate. For example, the certificate validity system 314 can determine whether a user has modified the subject of a certificate to gain more rights to access services or data provided through a network. In another example, the certificate validity system 314 can determine whether a user has modified a certificate to change whether a client device associated with a certificate is a BYOD or an employer owned device. In determining whether a certificate has been tampered with, the certificate validity system 314 can cryptographically determine whether a user has tampered with the certificate.

In a specific implementation, in determining validity of a certificate, the certificate validity system 314 functions to determine whether a certificate has been revoked, and is therefore not valid. In determining whether a certificate has been revoked, the certificate validity system 314 can use certificate data stored in the certificate datastore 310. Specifically, the certificate validity system 314 can look up in certificate data, based on an identification of a certificate, to determine whether the certificate has been revoked.

In a specific implementation, in determining validity of a certificate, the certificate validity system 314 functions to determine if a certificate is received from a device to which the certificate is bound, and is therefore valid. In determining whether a certificate is received from a client device that the certificate is bound to, the certificate validity system 314 can determine an identification of the client device, e.g. a MAC address of the client device from which the certificate is received. The certificate validity system 314 can also determine an identification of a client device that the certificate is bound to from certificate data stored in the certificate datastore 310. Further in determining whether a certificate is received from a client device that the certificate is bound to, the certificate validity system 314 can compare an identification of a client device to which the certificate is bound to an identification of a client device from which the certificate is received to determine if the client device that sends the certificate is the client device to which the certificate is bound.

In a specific implementation, the certificate based access rights determination system 316 functions to determine access rights for a client device to services and data provided through a network using a certificate received from the client device. Depending upon implementation-specific or other considerations, the certificate based access rights determination system 316 can determine access rights based on a certificate received from the client device. In determining access rights from a certificate received from a client device, the certificate based access rights determination system 316 can determine user information and device information included as part of the certificate and determine access rights based on the determined user information and device information. For example, the certificate based access rights determination system 316 can determine a group that a user of a client device is a member of from a certificate, and determine access rights for the client device based on the group of which the user of the client is a member. Depending upon implementation-specific or other considerations, the certificate based access rights determination system 316 can determine access rights from specific access rights stored in the access rights datastore 312 based on device information or user information determined from a certificate. Further depending upon implementation-specific or other considerations, the certificate based access rights determination system 316 can determine access rights from access rights rules stored in the access rights datastore 312 based on device information or user information determined form a certificate.

In a specific implementation, the certificate based access rights determination system 316 functions to determine access rights based on a certificate received from a client device and certificate data stored in the certificate datastore 310. The certificate based access rights determination system 316 can determine user information and device information from certificate data stored in the certificate datastore 310 that corresponds to a certificate received from a client device and determine access rights from the determined user information and device information. For example, the certificate based access rights determination system 316 can determine a group that a user of a client device is a member of from user information, included as part of certificate information, corresponding to a certificate received from the client device, and determine access rights based on the group of which the user of the client device is a member. In another example, the certificate based access rights determination system 316 can determine an identification of a user of a client device from user information, included as part of certificate information, corresponding to a certificate received from the client device, and determine access rights based on the identification of the user. Depending upon implementation-specific or other considerations, the certificate based access rights determination system 316 can determine access rights from specific access rights stored in the access rights datastore 312 based on determined device information or user information. Further depending upon implementation-specific or other considerations, the certificate based access rights determination system 316 can determine access rights from access rights rules stored in the access rights datastore 312 based on determined device information or user information.

In a specific implementation, the access management engine 318 functions to control access for a client device to services and data provided through a network to the client device based on determined access rights. In managing client device access to data and services through a network, the access management engine 318 can allow the client device or a user of the client device to utilize services and receive data authorized by the access rights determined specifically for the client device or a user of the client device. For example, if access rights indicate that a client device or a user of the client device is not allowed to receive streaming data, then the access management engine 318 can block streaming data, or an application running on the client device that uses streaming data. Specifically, if a client device attempts to stream a video through a web browser, then the access management engine 318 can stop the transmission of data used in streaming the video through the web browser.

In a specific implementation, the access management engine 318 functions to manage access to services and data based on whether it is determined that a certificate is valid, e.g. the certificate has not been tampered with, was sent by a client device that the certificate is bound to, and/or has not been revoked. Depending upon implementation-specific or other considerations, in managing access to services and data based on whether a certificate is valid, the access management engine 318 can deny access for a client device to services and data provided through a network. For example, the access management engine 318 can terminate a connection or not allow a client device to connect to a network that provides services or data if it determines that a certificate received from the client device is not valid. Further depending upon implementation-specific or other considerations, in managing access rights based on whether a certificate is valid, the access management engine 318 can limit access for a client device to services and data provided through a network. For example, the access management engine 318 can enroll a client device in a limited profile, e.g. a guest profile, and allow the client device to connect to a network through the limited profile if it is determined that a certificate sent by the client device is not valid. In the example, the profile can be limited with respect to access rights to services and data provided through the network. In another example, the access management engine 318 can give a client device access to a network, but place the client device in a user profile that contains only a captive web portal indicating that the certificate that the client device is using is not bound to the client device and the user must contact IT.

In an example of operation of the example system shown in FIG. 3, the certificate validity system determines whether a certificate received from a client device that is coupled to a network through the network device 306 is valid. In the example of operation, the certificate validity system determines whether the certificate is valid using certificate data stored in the certificate datastore 310. Further in the example of operation of the example system shown in FIG. 3, the certificate based access rights determination system determines access rights using the certificate, certificate data stored in the certificate datastore 310, and access rights data stored in the access rights datastore 312. In the example of operation of the example system shown in FIG. 3, the access management engine 318 manages access for the client device 304 to services and data provided through the network based on access rights determined by the certificate based access rights determination system 316.

FIG. 4 depicts a diagram 400 of an example of a system for determining whether a certificate received from a client device is valid. The example system shown in FIG. 4 includes a computer-readable medium 402, a client device 404, a network device 406, a certificate validity system 408, and a certificate datastore 410. In the example system shown in FIG. 4, the client device 404 is coupled to the network device 406 and the network device, the certificate validity system 408, and the certificate datastore 410 are coupled to each other through the computer-readable medium 402.

In a specific implementation, the client device 404 functions according to an applicable device for sending and receiving data through a network, such as the client devices described in this paper. In receiving data through a network, the client device 404 can receive a certificate that is assigned to the client device 404. Additionally, in receiving data through a network, the client device 404 can access services or data provided through the network. In sending data through a network, the client device 404 can send a certificate that is assigned to the client device 404.

In a specific implementation, the network device 406 functions according to an applicable device for coupling a client device to a network, such as the network devices described in this paper. In coupling a client device to a network, the network device 406 can send and receive data between a network and a client device that is coupled to the network device 406. Depending upon implementation-specific or other considerations, a client device can be coupled to the network device 406 through a wired or wireless connection.

In a specific implementation, the certificate validity system 408 functions according to an applicable system for determining validity of a certificate, such as the certificate validity systems described in this paper. In determining validity of a certificate, the certificate validity system 408 can determine whether the certificate has been tampered with. Further in determining validity of a certificate, the certificate validity system 408 can determine whether the certificate has been revoked. In determining validity of a certificate, the certificate validity system 408 can determine whether the certificate is received from a client device that is bound to the certificate.

In a specific implementation, the certificate datastore 410 functions according to an applicable datastore for storing certificate data, such as the certificate datastores described in this paper. Certificate data stored in the certificate datastore 410 can include a certificate or an identification of the certificate assigned to a specific device. In including a certificate or an identification of the certificate as part of certificate data, certificate data stored in the certificate datastore 410 can be arranged as a table, with the certificate or the identification of the certificate as an index in the table. Certificate data stored in the certificate datastore 410 can also include user information and device information. For example, certificate data stored in the certificate datastore 410 can include an identification of a client device, e.g. MAC address of the client device. Certificate data stored in the certificate datastore 410 can also indicate whether a certificate has been revoked.

In the example system shown in FIG. 4, the certificate validity system 408 includes a cryptographic validity engine 412, a certificate validity engine 414, and a device binding determination engine 416. In a specific implementation the cryptographic validity engine 412 functions to determine whether a user has tampered with a certificate received from the client device 404, and the certificate is therefore not valid. The cryptographic validity engine 412 can determine whether a user has modified a certificate. For example, the cryptographic validity engine 412 can determine whether a user has modified the subject of a certificate to gain more rights to access services or data provided through a network. In another example, the cryptographic validity engine 412 can determine whether a user has modified a certificate to change whether a client device associated with a certificate is a BYOD or an employer owned device. In determining whether a certificate has been tampered with, the cryptographic validity engine 412 can cryptographically determine whether a user has tampered with the certificate.

In a specific implementation, the certificate validity engine 414 functions to determine whether a certificate has been revoked, and is therefore not valid. In determining whether a certificate has been revoked, the certificate validity engine 414 can use certificate data stored in the certificate datastore 410. Specifically, the certificate validity engine 414 can look up in certificate data, based on an identification of a certificate, to determine whether the certificate has been revoked.

In a specific implementation, the device binding determination engine 416 functions to determine if a certificate is received from a device to which the certificate is bound, and is therefore valid. In determining whether a certificate is received from a client device that the certificate is bound to, the device binding determination engine 416 can determine an identification of the client device, e.g. a MAC address of the client device from which the certificate is received. The device binding determination engine 416 can also determine an identification of a client device that the certificate is bound to from certificate data stored in the certificate datastore 410. Further in determining whether a certificate is received from a client device that the certificate is bound to, the device binding determination engine 416 can compare an identification of a client device to which the certificate is bound to an identification of a client device from which the certificate is received to determine if the client device that sends the certificate is the client device to which the certificate is bound.

In an example of operation of the example system shown in FIG. 4, the cryptographic validity engine 412 determines whether a certificate received from the client device 404 through the network device 406 has been tampered with. In the example of operation, the certificate validity engine 414 determines whether the certificate has been revoked using certificate data stored in the certificate datastore 410. Further in the example of operation, the device binding determination engine determines whether the certificate received from the client device 404 is bound to the client device 404 using certificate data stored in the certificate datastore 410.

FIG. 5 depicts a diagram 500 of an example of a system for determining access rights for a client device to services and data provided through a network based on a certificate received from the client device. The example system shown in FIG. 5 includes a computer-readable medium 502, a client device 504, a network device 506, a certificate based access rights determination system 508, a certificate datastore 510, and an access rights datastore 512. In the example system shown in FIG. 5, the client device 504 is coupled to the network device 506 and the network device 506, the certificate based access rights determination system 508, certificate datastore 510, and the access rights datastore 512 are coupled to each other through the computer-readable medium 502.

In a specific implementation, the client device 504 functions according to an applicable device for sending and receiving data through a network, such as the client devices described in this paper. In receiving data through a network, the client device 504 can receive a certificate that is assigned to the client device 504. Additionally, in receiving data through a network, the client device 504 can access services or data provided through the network. In sending data through a network, the client device 404 can send a certificate that is assigned to the client device 504.

In a specific implementation, the network device 506 functions according to an applicable device for coupling a client device to a network, such as the network devices described in this paper. In coupling a client device to a network, the network device 506 can send and receive data between a network and a client device that is coupled to the network device 506. Depending upon implementation-specific or other considerations, a client device can be coupled to the network device 506 through a wired or wireless connection.

In a specific implementation, the certificate based access rights determination system 508 functions according to an application system for determining access rights for a client device to services and data provided through a network based on a certificate received from the client device, such as the certificate based access rights determination systems described in this paper. Access rights determined by the certificate based access rights determination system 508 can be used to manage access for a client device to services and data provided through a network.

In a specific implementation, the certificate datastore 510 functions according to an applicable datastore for storing certificate data, such as the certificate datastore described in this paper. Certificate data stored in the certificate datastore 510 can include a certificate or an identification of the certificate assigned to a specific device. In including a certificate or an identification of the certificate as part of certificate data, certificate data stored in the certificate datastore 510 can be arranged as a table, with the certificate or the identification of the certificate as an index in the table. Certificate data stored in the certificate datastore 510 can also include user information and device information. For example, certificate data stored in the certificate datastore 510 can include an identification of a client device, e.g. MAC address of the client device.

In a specific implementation, the access rights datastore 512 functions according to an applicable datastore for storing access rights data, such as the access rights datastores described in this paper. Access rights data stored in the access rights datastore 512 can include access rules that are used to determine a degree of which to provide access to services or data provided through a network to a client device based on user information of a user using the client device or client device information of the client device. Access data stored in the access rights datastore 512 can also include specific access rules that are specific to a client device or a user of a client device.

In the example system shown in FIG. 5, the certificate based access rights determination system 508 includes a device information determination engine 514, a user information determination engine 516, and an access rights determination engine 518. In a specific implementation, the device information determination engine 514 functions to determine device information of a client device from which a certificate is received. Depending upon implementation-specific or other considerations, the device information determination engine 514 can determine device information from either or both a certificate that is received from a client device or certificate data stored in the certificate datastore 510. For example, if a certificate includes device information, the device information determination engine 514 can determine device information from the certificate. Additionally, the device information determination engine 514 can determine device information from certificate data that includes device information associated with the certificate.

In a specific implementation, the user information determination engine 516 functions to determine user information of a user of a client device from which a certificate is received. Depending upon implementation-specific or other considerations, the user information determination engine 516 can determine user information from either or both a certificate that is received from a client device or certificate data stored in the certificate datastore 510. For example, if a certificate includes user information, the user information determination engine 516 can determine user information from the certificate. Additionally, the user information determination engine 516 can determine user information from certificate data that includes user information associated with the certificate.

In a specific implementation, the access rights determination engine 518 functions to determine access rights for a client device or a user of the client device. Depending upon implementation-specific or other considerations, the access rights determination engine 518 can determine access rights based on a certificate received from the client device. In determining access rights from a certificate received from a client device, the certificate based access rights determination system 516 can determine access rights from user information and device information included as part of the certificate and determined by the device information determination engine 514 and the user information determination engine 516. Further, in determining access rights from a certificate received from a client device, the certificate based access rights determination system 516 can determine access rights from user information and device information included as part of certificate information stored in the certificate datastore 510 determined by the device information determination engine 514 and the user information determination engine 516.

In an example of operation of the example system shown in FIG. 5, the device information determination engine 514 determines device information of the client device 504 that sends a certificate, using the certificate. In the example of operation, the user information determination engine 516 determines user information of a user using the client device 504 form the certificate. Further in the example of operations, the access rights determination engine 518 determines access rights for the client device 504 or a user of the client device 504 from user information determined by the user information determination engine 516 and device information determined from the device information determination engine 514.

FIG. 6 depicts a flowchart 600 of an example of a method for generating a certificate for a client device or a user of a client device for use in managing access to services and data provided through a network. The flowchart 600 begins at module 602, where device information of a client device is determined. Device information determined at module 602 can include an identification of the client device, e.g. a MAC address of the client device. Device information determined at module 602 can also include whether the client device is a BYOD or an employer owned device.

The flowchart 600 continues to module 604, where user information of a user of the client device is determined. User information determined at module 604 can include a group, e.g. IT, of which a user of the client device is a member. User information determined at module 604 can also include an identification of a user of the client device.

The flowchart 600 continues to module 606, where a certificate is generated for the client device or the user of the client device. A certificate generated at module 606 can be specific to the client device or the user of the client device. Depending upon implementation-specific or other considerations, a certificate generated at module 606 can include either or both device information determined at module 602 and user information determined at module 604. For example, if user information indicates that a user of the client device is a member of the IT group, then a certificate generated for a client device used by the user can include an indication that the user is a member of the IT group.

The flowchart 600 continues to module 608, where a certificate is bound to a client device for which it is created. In binding a certificate to a client device, an identification of a client device, e.g. a MAC address of the client device, is associated with a certificate that is created for the client device. Further in binding a certificate to a client device, certificate data is updated to include the certificate or an identification of the certificate and an identification of the client device associated with the certificate.

The flowchart 600 continues to module 610, where user information of a user of the client device determined at module 604 and device information of the client device determined at module 602 are associated with the certificate. The user information and the device information associated with the certificate can be stored as certificate data along with the certificate or an identification of the certificate. The user information and the device information associated with the certificate can be used to determine access rights for the client device or a user of the client device.

The flowchart 600 continues to module 612, where the certificate is sent to the client device. In sending the certificate to the client device, the certificate can be used to determine access rights for the client device to services and data provided through a network if the client device is coupled to the network or attempts to couple to the network.

FIG. 7 depicts a flowchart 700 of an example of a method for determining validity of a certificate received from a client device for accessing services or data provided through a network. The flowchart 700 begins at module 702, where a certificate is received from a client device. The certificate can include user information of a user of a client device and device information of the client device.

The flowchart 700 continues to module 704, where it is determined whether the certificate received from the client device has been tampered. For example, it can be determined at module 704, whether the certificate has been changed to indicate that the client device is an employer owned device rather than a BYOD. Applicable cryptographic techniques can be used to determine whether the certificate has been tampered with at module 704. If it is determined that the certificate has been tampered with, it can be determined that the certificate is invalid.

The flowchart 700 continues to module 706, where it is determined whether the certificate has been revoked. Whether a certificate has been revoked can be determined from certificate data of the certificate. The certificate can be revoked if it is determined that the certificate has been tampered. The certificate can also be revoked if, during a previous session or the current session, it is determined that the certificate is received form a client device to which the certificate is not bound. If it is determined that a certificate has been revoked, then it can be determined that the certificate is invalid.

The flowchart 700 continues to module 708, where it is determined whether the certificate is received from a client device to which the certificate is bound. It can be determined whether the certificate is received from a client device to which the certificate is bound by comparing an identification, e.g. MAC address, of the client device from which the certificate is received to an identification, e.g. MAC address, of a client device that is bound to the certificate. An identification, e.g. MAC address of a client device that is bound to the certificate can be determined from certificate data. If it is determined that the certificate is received from a client device that is not a client device that is bound to the certificate, then the certificate can be determined to be invalid.

The flowchart 700 continues to module 710, where access rights of the client device are managed based on whether the certificate is determined to be valid, e.g. the certificate has not been tampered with, was sent by a client device that the certificate is bound to, and/or has not been revoked. Depending upon implementation-specific or other considerations, in managing access to services and data based on whether a certificate is valid, access for the client device to services and data provided through a network can be denied. For example, a connection between a network and the client device can be terminated or the client device can be prevented from connection to the network if it is determined that the certificate received from the client device is not valid. Further depending upon implementation-specific or other considerations, access for the client device to services and data provided through a network can be limited if it is determined that the certificate is invalid. For example, the client device can be enrolled in a limited profile, e.g. a guest profile, which allows the client device to connect to a network through the limited profile. In the example, the profile can be limited with respect to access rights to services and data provided through the network. In another example, if it is determined that the certificate is invalid, then the client device can be given access to a network, but placed in a user profile that contains only a captive web portal indicating that the certificate that the client device is using is not bound to the client device and the user must contact IT.

FIG. 8 depicts a flowchart 800 of an example of a method for determining access rights for a client device to services and data provided through a network using a certificate received from the client device. The flowchart 800 begins at module 802, where a certificate is received from a client device. A certificate received from a client device can include either or both device information of the client device and user information of a user of the client device.

The flowchart 800 continues to module 804, where user information is determined using the certificate received at module 802. Depending upon implementation-specific or other considerations, user information can be determined directly from the certificate, if user information is included in the certificate. Further depending upon implementation-specific or other considerations, user information can be determined using the certificate and certificate data corresponding to the certificate. For example, certificate data corresponding to the certificate can specify user information of a user of the client device of which the certificate is specific.

The flowchart 800 continues to module 806, where device information is determined using the certificate received at module 802. Depending upon implementation-specific or other considerations, device information can be determined directly from the certificate, if device information is included in the certificate. Further depending upon implementation-specific or other considerations, device information can be determined using the certificate and certificate data corresponding to the certificate. For example, certificate data corresponding to the certificate can specify device information of a client device of which the certificate is specific.

The flowchart 800 continues to module 808, where access rights are determined using the certificate. In determining access rights using the certificate, user information determined at module 804 and device information determined at module 806 can be used to determine access rights. Depending upon implementation-specific or other considerations, access rights can be determined from specific access rights included as access rights data. Further depending upon implementation-specific or other considerations, access rights can be determined from access rights rules included as access rights data.

The flowchart 800 continues to module 810, where access to services or data provided through a network is managed based on the access rights. In managing access to data and services through a network for the client device, the client device or a user of the client device can be allowed to utilize services and receive data authorized by the determined access rights. For example, if access rights indicate that a client device or a user of the client device is not allowed to receive streaming data, then streaming data, or an application running on the client device that uses streaming data can be blocked.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving a certificate from a client device, the client device being either a Bring-Your-Own-Device (“BYOD”) or an employer owned device;
determining user information of a user of the client device using the certificate;
determining device information of the client device using the certificate;
determining access rights for the client device to services or data provided through a network by a network device to which the client device is coupled, using the user information and the device information;
managing access to the services or data provided through the network using the determined access rights.

2. The method of claim 1, wherein the device information indicates whether the client device is a BYOD or a company owned device.

3. The method of claim 1, wherein the user information indicates a group of which the user is a member.

4. The method of claim 1, further comprising:
determining whether the certificate is valid;
managing access to the services or data provided through the network based on whether the certificate is determined valid.

5. The method of claim 4, wherein determining whether the certificate is valid further comprises:
determining whether the certificate has been tampered with;
determining that the certificate is invalid if it is determined that the certificate has been tampered with.

6. The method of claim 4, wherein determining whether the certificate is valid further comprises:
determining whether the certificate has been revoked;
determining that the certificate is invalid if it is determined that the certificate has been revoked.

7. The method of claim 4, wherein determining whether the certificate is valid further comprises:
determining whether the certificate is bound to the client device;
determining that the certificate is invalid if it is determined that the certificate is not bound to the client device.

8. The method of claim 1, further comprising, generating the certificate for the client device regardless of whether the client device, further comprising:
determining the user information of the user of the client device;
determining the device information of the client device;
associating the user information and the device information with the certificate;
generating certificate information that includes an identification of the certificate and the user information and the device information, the certificate information used to determine the access rights for the client device to the services or data provided through the network.

9. The method of claim 1, further comprising, generating the certificate for the client device regardless of whether the client device, further comprising:
determining the user information of the user of the client device;
determining the device information of the client device;
including the user information and the device information in the certificate.

10. The method of claim 6, wherein the certificate is revoked if it is determined during a previous session that the certificate has been tampered with or that the certificate is not bound to the client device.

11. A system comprising:
a certificate based access rights determination system configured to receive a certificate from a client device, the client device being either a Bring-Your-Own-Device (“BYOD”) or an employer owned device;
a user information determination engine configured to determine user information of a user of the client device using the certificate;
a device information determination engine configured to determine device information of the client device using the certificate;
an access rights determination engine configured to determine access rights for the client device to services or data provided through a network by a network device to which the client device is coupled, using the user information and the device information;
an access management engine configured to manage access to the services or data provided through the network using the determined access rights.

12. The system of claim 11, wherein the device information indicates whether the client device is a BYOD or a company owned device.

13. The system of claim 11, wherein the user information indicates a group of which the user is a member.

14. The system of claim 11, further comprising:
a certificate validity system configured to determine whether the certificate is valid;
the access management engine further configured to manage access to the services or data provided through the network based on whether the certificate is determined valid.

15. The system of claim 14, wherein the certificate validity system is further configured to:
determine whether the certificate has been tampered with;
determine that the certificate is invalid if it is determined that the certificate has been tampered with.

16. The system of claim 14, wherein the certificate validity system is further configured to:
determine whether the certificate has been revoked;
determine that the certificate is invalid if it is determined that the certificate has been revoked.

17. The system of claim 14, wherein the certificate validity system is further configured to:
determine whether the certificate is bound to the client device;
determine that the certificate is invalid if it is determined that the certificate is not bound to the client device.

18. The system of claim 11, further comprising a certificate assignment system configured to:
determine the user information of the user of the client device;
determine the device information of the client device;
associate the user information and the device information with the certificate;
generate certificate information that includes an identification of the certificate and the user information and the device information, the certificate information used to determine the access rights for the client device to the services or data provided through the network.

19. The system of claim 11, further comprising a certificate assignment system configured to:
determining the user information of the user of the client device;
determining the device information of the client device;
generate the certificate by including the user information and the device information into the certificate.

20. The system of claim 16, wherein the certificate is revoked if it is determined during a previous session that the certificate has been tampered with or that the certificate is not bound to the client device.

21. A system comprising:
means for receiving a certificate from a client device, the client device being either a Bring-Your-Own-Device (“BYOD”) or an employer owned device;
means for determining user information of a user of the client device using the certificate;
means for determining device information of the client device using the certificate;
means for determining access rights for the client device to services or data provided through a network by a network device to which the client device is coupled, using the user information and the device information;
means for managing access to the services or data provided through the network using the determined access rights.
